(19) United States
(12) Patent Application Publication
(10) Pub. No.: US 2017/0351732 A1
(43) Pub. Date: Dec. 7, 2017

(54) METHOD AND SYSTEM FOR AUTOMATIC UPDATE OF POINT OF INTEREST

(71) Applicant: NAVER CORPORATION, Seongnam-si (KR)

(72) Inventor: Jeanie Jung, Seongnam-si (KR)

(21) Appl. No.: 15/610,897

(22) Filed: Jun. 1, 2017

(30) Foreign Application Priority Data
Jun. 2, 2016 (KR) 10-2016-0068615

(51) Int. Cl. G06F 17/30; G06T 19/00; G06F 3/0484; G06T 17/05

(52) U.S. Cl. CPC G06F 17/30377; G06T 17/05; G06T 19/003; G06F 3/0484; G06F 17/30241; G06T 2219/024

(57) ABSTRACT

Provided is a method and system for automatically updating a point of interest in a virtual exploration environment. The automatic update method may include marking a specific point in a virtual exploration environment using a panoramic image; updating information data associated with the specific point using location information corresponding to the specific point; and providing update information associated with the specific point to a user that marks the specific point.

### CROSS-REFERENCE TO RELATED APPLICATION(S)

This application claims priority under 35 U.S.C. §119 to Korean Patent Application No. 10-2016-0068615 filed on Jun. 2, 2016, in the Korean Intellectual Property Office (KIPO), the entire contents of which are incorporated herein by reference.

### BACKGROUND

### Field

One or more example embodiments of the present invention relate to technology for automatically updating a point of interest on a space in a virtual exploration environment.

### Description of Related Art

Many users are interested in virtual reality contents with the increasing interest in virtual reality. For example, Korean Patent Publication No. 10-2002-0078141, published on Oct. 18, 2002, discloses “a moving picture virtual reality image construction system and a method thereof” that acquires an object video using a plurality of video cameras and displays the acquired object video on a viewer in real time through a network.

Recent online or locally stored map services provide an actual image photo of a street, such as a street view, an aerial view, etc., in a 360-degree panoramic format, on a display screen, allowing a user to experience a virtual exploration environment as if the user walks in an actual region or is taking a vehicle or an airplane.

Data included in such a panoramic image may include famous tourist attractions, landmarks, natural landscapes, and various point of interest (POI) photos as well as simple information. Thus, users may experience virtual tours. In this aspect, many users may visit regions or places associated with personal memories, for example, a hometown, a school, etc, through a virtual exploration environment, such as a street view, an aerial view, and the like.

Although a user desires to verify an appearance, recent information, etc., associated with a specific point in a virtual exploration environment, the user may need to search a corresponding region every time and verify whether an update has been performed due to an absence of separate update technology.

### SUMMARY

One or more example embodiments provide a method and system that automatically updates a marked point of interest in a virtual exploration environment.

According to an aspect of at least one example embodiment, there is provided an automatic update method performed at an automatic update system configured as a computer, the method including marking a specific point based on a virtual exploration environment using a panoramic image; updating information data associated with the specific point using location information corresponding to the specific point; and providing update information associated with the specific point to a user that marks the specific point.

The marking may include marking the specific point in response to viewing the virtual exploration environment associated with the specific point.

The marking may include marking the specific point in response to creating image content associated with the specific point using the virtual exploration environment.

The updating may include updating information data included in a virtual exploration environment of the specific point.

The updating may include updating information data associated with location information corresponding to the specific point.

The updating may include updating push information associated with location information corresponding to the specific point.

The updating may include updating information associated with users that mark the same point as the specific point or a point adjacent to the specific point.

The updating may include updating tagging information associated with location information corresponding to the specific point.

The updating may include updating advertising content set with respect to location information corresponding to the specific point.

The providing may include providing an alarm about update information associated with the specific point.

The providing may include applying update information associated with the specific point to a personal album of the user.

The providing may include rendering update information associated with the specific point and representing the rendered update information on a virtual exploration environment of the specific point as virtual reality content.

The automatic update method may further include providing a virtual space allowing users that mark the specific point to share data with respect to the specific point.

The automatic update method may further include providing an alarm to at least a portion of the users that mark the specific point in response to uploading of the data through the virtual space.

According to an aspect of at least one example embodiment, there is provided a non-transitory computer-readable medium storing computer-readable instructions that, when executed by a processor, cause the processor to perform an automatic update method including marking a specific point based on a virtual exploration environment using a panoramic image; updating information data associated with the specific point using location information corresponding to the specific point; and providing update information associated with the specific point to a user that marks the specific point.

According to an aspect of at least one example embodiment, there is provided an automatic update system configured as a computer, including a point marker configured to mark a specific point based on a virtual exploration environment using a panoramic image; an updater configured to update information data associated with the specific point using location information corresponding to the specific point; and an information manager configured to provide update information associated with the specific point to a user that marks the specific point.

The information manager may be configured to provide an alarm about update information associated with the specific point.

According to some example embodiments, it is possible to construct a timeline archive about a virtual exploration environment of a point of interest by automatically updating a marked point of interest in the virtual exploration environment.

Also, according to some example embodiments, it is possible to automatically attach recent information associated with a corresponding region in response to updating of a point of interest of a user or to automatically transmit or provide an alarm about the recent information, so that the user may easily track a change in the point of interest without performing search every time.

Further areas of applicability will become apparent from the description provided herein. The description and specific examples in this summary are intended for purposes of illustration only and are not intended to limit the scope of the present disclosure.

### BRIEF DESCRIPTION OF THE FIGURES

Example embodiments will be described in more detail with regard to the figures, wherein like reference numerals refer to like parts throughout the various figures unless otherwise specified, and wherein:

FIG. 1 is a diagram illustrating an example of a configuration of a computer system according to one example embodiment;

FIG. 2 is a block diagram illustrating an example of components included in a processor of a computer system according to one example embodiment;

FIG. 3 is a flowchart illustrating an example of an automatic update method performed at a computer system according to one example embodiment;

FIGS. 4 through 6 illustrate examples of a process of marking a point of interest according to at least one example embodiment;

FIG. 7 is a flowchart illustrating an example of a process of automatically updating a point of interest according to one example embodiment; and

FIG. 8 is a flowchart illustrating an example of a process of providing update information associated with a point of interest according to one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

The example embodiments relate to technology for automatically updating a point of interest (POI), and more particularly, to a method and system for automatically updating a marked POI in a virtual exploration environment. The example embodiments that include the disclosure herein may perform an automatic update of a POI on a space in a virtual exploration environment and, through this, may achieve various advantages in terms of, for example, efficiency, convenience, variety, cost reduction, and the like.

A panoramic image disclosed herein may include a three-dimensional (3D) image, a multi-view image, for example, a 360-degree image, a virtual reality (VR) image, and the like, and may inclusively indicate any image content in a panoramic format provided using an online or locally stored map service of a street view, an aerial view, and the like, a broadcasting service, a virtual reality environment, and the like.

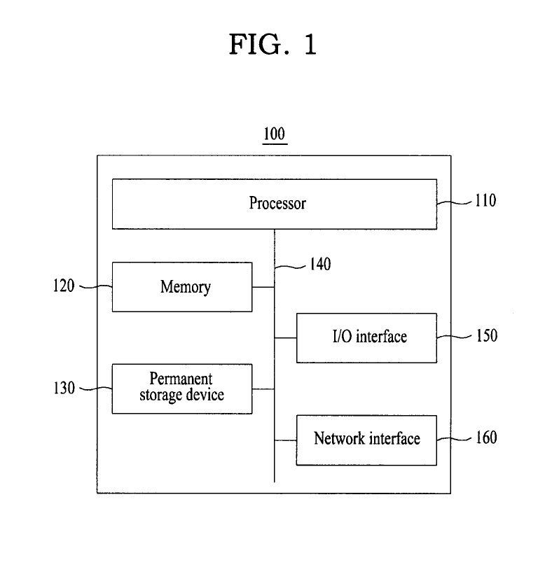

FIG. 1 is a block diagram illustrating an example of a computer system according to one example embodiment. For example, an automatic update system according to example embodiments may be configured through a computer system 100 of FIG. 1. Referring to FIG. 1, the computer system 100 includes a processor 110, a memory 120, a permanent storage device 130, a bus 140, an input/output (I/O) interface 150, and a network interface 160 as components for implementing an automatic update method.

The processor 110 may include an apparatus capable of processing a sequence of instructions or may be a portion thereof. The processor 110 may include, for example, a computer processor, or a processor and/or a digital processor within another electronic device. The processor 110 may be included in, for example, a server computing device, a server computer, a series of server computers, a server farm, a cloud computer, a content platform, a mobile computing device, a smartphone, a tablet, a set-top box, a media player, and the like. The processor 110 may be connected to the memory 120 through the bus 140.

The memory 120 may include a volatile memory, a permanent memory, a virtual memory, and/or another memory to store information used by the computer system 100 or output from the computer system 100. The memory 120 may include, for example, random access memory (RAM) and/or dynamic random access memory (DRAM). The memory 120 may be used to store predetermined information, such as state information of the computer system 100. The memory 120 may be used to store instructions of the computer system 100 including, for example, instructions for automatic update of a point on a space in a virtual exploration environment.

The bus 140 may include a communication-based structure that enables interaction between various components of the computer system 100. The bus 140 may transfer data between components of the computer system 100, for example, between the processor 110 and the memory 120. The bus 140 may include wireless and/or wired communication media between components of the computer system 100, and may include parallel, serial, and/or other topology arrangements.

The permanent storage device 130 may store data during a predetermined extended period. The permanent storage device 130 may include a non-volatile main memory used by the processor 110 of the computer system 100. The permanent storage device 130 may include, for example, a flash memory, a hard disk, an optical disc, and/or another computer-readable media.

The I/O interface 150 may include interfaces associated with a keyboard, a mouse, a voice command input, a display, and/or another input or output device. Instructions and/or input for the automatic update may be received through the I/O interface 150.

The network interface 160 may include at least one interface for networks, such as a near field network, the Internet, and the like. The network interface 160 may include interfaces for wired and/or wireless accesses. The instructions may be received through the network interface 160, and information associated with the automatic update may be received or transmitted through the network interface 160.

According to other example embodiments, the computer system 100 may include a greater or lesser number of components than the number of components shown in FIG. 1. However, there is no need to clearly illustrate many components according to the related art. For example, the computer system 100 may include at least a portion of I/O devices connected to the I/O interface 150 or may further include other components, for example, a transceiver, a global positioning system (GPS) module, a camera, a variety of sensors, a database, and the like. In detail, when the computer system 100 is configured in a form of a mobile device such as a smartphone, the computer system 100 may further include other components, for example, an accelerometer sensor, a gyro sensor, a camera, various types of buttons, a button using a touch panel, an I/O port, a vibrator for vibration, etc., which are generally included in the smartphone.

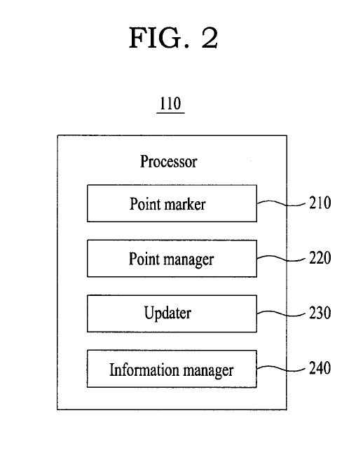

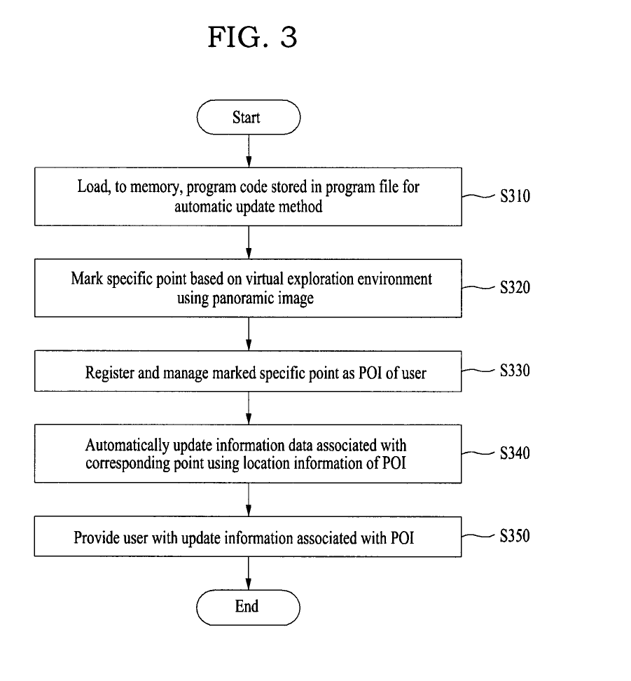

FIG. 2 is a block diagram illustrating an example of components includable in a processor of a computer system according to at least one example embodiment, and FIG. 3 is a flowchart illustrating an example of an automatic update method performed at a computer system according to at least one example embodiment.

Referring to FIG. 2, the processor 110 includes a point marker 210, a point manager 220, an updater 230, and an information manager 240. The components of the processor 110 may be representations of different functions performed by the processor 110 in response to a control instruction provided by at least one program code. For example, the point marker 210 may be used as a functional representation for the processor 110 to control the computer system 100 to mark a specific point on a space in a virtual exploration environment. The processor 110 and the components of the processor 110 may be configured to perform operations S310 through S350 included in the automatic update method of FIG. 3. For example, the processor 110 and the components of the processor 110 may be configured to execute instructions according to the at least one program code and a code of an OS included in the memory 120. Here, the at least one program code may correspond to a code of a program configured to process the automatic update method.

The automatic update method may not be performed in the illustrated order. A portion of the operations may be omitted from the map image search method, or an additional process may be further included in the map image search method.

In operation S310, the processor 110 loads, to the memory 120, a program code stored in a program file for the automatic update method. For example, the program file for the automatic update method may be stored in the permanent storage device 130 of FIG. 1. The processor 110 may control the computer system 100, so that the program code may be loaded from the program file stored in the permanent storage device 130 to the memory 120 through the bus 140. Here, the processor 110 and the point marker 210, the point manager 220, the updater 230, and the information manager 240 included in the processor 110 may be different functional representations of the processor 110 to execute an instruction of a portion corresponding to the program code loaded to the memory 120 and to implement operations S320 through S350, respectively. To perform operations S320 through S350, the processor 110 and the components of the processor 110 may directly process an operation in response to a control instruction or may control the computer system 100 to process the operation.

In operation S320, the point marker 210 marks a specific point in a virtual exploration environment using a panoramic image. For example, the point marker 210 may mark a corresponding region in a virtual exploration environment in response to a user viewing the virtual exploration environment, for example, a street view, an aerial view, a VR environment, and the like, of a specific region through exploration of the specific region. For example, the point marker 210 may mark a corresponding point in a virtual exploration environment in response to the user viewing a street view of a specific point in the virtual exploration environment. As another example, if the user creates new image content by performing 360-degree capturing of content associated with a desired point in a virtual exploration environment through a capturing tool provided in the virtual exploration environment, the point marker 210 may mark the desired point of the created image content. For example, if the user creates street view content by capturing a desired point during a process of viewing a street view in a virtual exploration environment, the point marker 210 may mark a point on the created street view content. Although marking a specific point through the virtual exploration environment is herein described, it is provided as an example only. Marking of a specific point may be performed through a general search, pre-settings, and the like, without using the virtual exploration environment. In addition, any searchable regions using the virtual exploration environment may be included in a marking target range by securing panoramic images in advance.

In operation S330, the point manager 220 registers and manage the specific point marked in the virtual exploration environment as a point of interest (POI) of the user. For example, the point manager 220 may register, as the POI of the user, location information, global positioning system (GPS) coordinates, and the like, corresponding to the specific point marked in the virtual exploration environment. A place viewed or a place created as new video content through the virtual exploration environment, such as a street view and the like, may be a place the user has previously visited or is to visit, a place that is meaningful to the user, such as a hometown, a school, and the like. The point manager 320 may automatically mark the place in the virtual exploration environment and may register the marked place as a POI of the user.

In operation S340, the updater 230 automatically updates information data associated with the corresponding point in the virtual exploration environment using location information of the POI. For example, the updater 230 may update information data included in the virtual exploration environment of the corresponding point with respect to the POI of the user. As another example, the updater 230 may update information data, for example, related photos, related news, related blogs, etc., associated with the location information corresponding to the POI.

In operation S350, the information manager 240 provides the user with update information associated with the POI of the user. Here, if information data included in the virtual exploration environment of the POI is updated or if information data associated with location information corresponding to the POI is updated, the information manager 240 may automatically archive or raise an alarm concerning the corresponding update information. In this manner, a timeline archive about the virtual exploration environment of the POI may be constructed. The information manager 240 may notify the user about a change in a place meaningful to the user through various methods. That is, the information manager 240 may provide an environment in which the user may automatically and easily track the change in such places without a need to search the corresponding places directly.

Further, the information manager 240 may provide a virtual space in which users marking the corresponding point may share data, for example, texts, images, moving pictures, etc., with respect to the specific point marked in the virtual exploration environment. For example, a data sharing space may be included in the virtual exploration environment or may be provided as a user interface connectable to the virtual exploration environment. If a single user marks the specific point in the virtual exploration environment and uploads data through a virtual space associated with the corresponding point, the information manager 240 may provide an alarm about the uploaded data to at least a portion of other users that mark the specific point in the same virtual exploration environment. For example, the information manager 240 may provide a space in which users marking the specific point may upload and share writing. Once new writing is posted to the corresponding space, the information manager 240 may provide an alarm about the new writing to users that mark the specific point. Here, the information manager 240 may provide an alarm about new writing to any user that marks the specific point, or may conditionally provide the alarm to at least a portion of users that agree to receive the alarm.

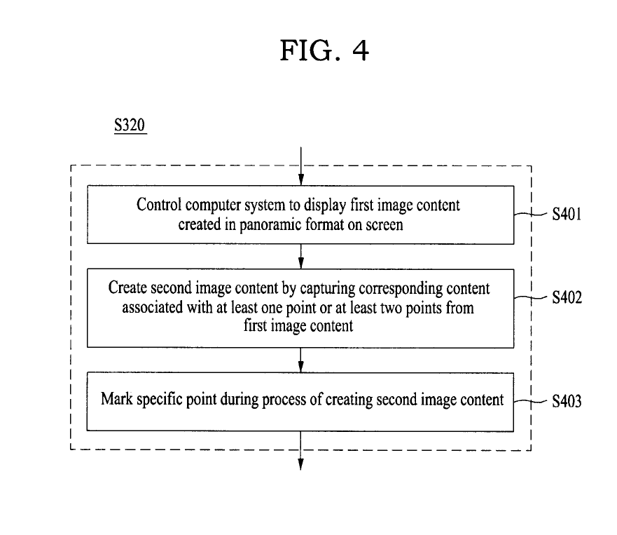

FIG. 4 is a flowchart illustrating a POI marking method performed by the point marker 210 according to one example embodiment. Operations S401 through S403 of FIG. 4 may be included in operation S320 of FIG. 3 and thereby performed.

In operation S401, the point marker 210 controls the computer system 100 to display first image content created in a panoramic format on a screen of the computer system 100. The point marker 210 may control the computer system 100 to display a panoramic image provided through a broadcasting service, a street view service, a virtual reality environment, etc., on the screen. The first image content may indicate any image content in the panoramic format, and may include, for example, a three-dimensional (3D) image, a multi-view image such as a 360-degree image, a virtual reality (VR) image, and the like. For example, the computer system 100 may be the same computer system that provides a street view through a map service, and may output a street view image, that is, a panoramic image, through map recommendation, search, navigation, etc. Here, the point marker 210 may provide the virtual exploration environment based on the panoramic image by outputting an image of a corresponding point in the panoramic format while moving points of a street view consecutively or inconsecutively.

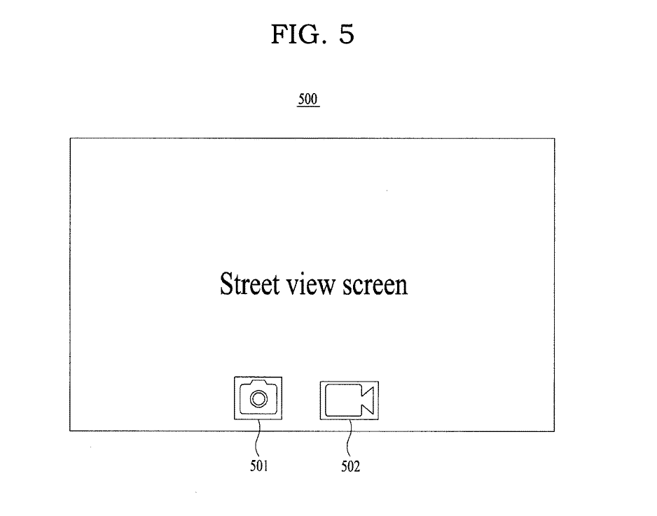

The point marker 210 may control the computer system 100 to display a user interface for manipulating or creating image content on the screen. For example, the point marker 210 may display a user interface that includes menus for inputting a user command associated with creation of new image content on the screen on which the first image content is displayed. A general street view service provides an actual photo image of a street in a 360-degree panoramic format. Referring to FIG. 5, a user interface required for creating image content may be displayed on a street view screen 500 that provides an actual street photo of a region as a 360-degree panorama. For example, a photographing menu 501 for creating image content in a static image format and a moving picture menu 502 for creating image content in a moving picture format may be displayed on the street view screen 500. The user may select a point or a section from the street view that is displayed on the street view screen 500 and then may request creation of image content associated with the selected point using the photographing menu 501 or may request creation of image content associated with the selected section using the moving picture menu 502. The street view image may be viewed with the image being rotated 360 degrees, which differs from general photos. Thus, the user may select up/down/left/right center point of the entire scene on the street view screen 500 and, in response to a content creation request from the user, the computer system 100 may acquire a 360-degree static image or a 360-degree moving picture of the street view based on the center point selected by the user.

Referring again to FIG. 4, in operation S402, the point marker 210 may create second image content from the first image content by capturing corresponding content associated with at least one point or at least two points from the first image content in the virtual exploration environment. In response to receiving a selection on at least one point or at least two points during a process of outputting the first image content, the point marker 210 may acquire a static image or a moving picture in a panoramic format based on the corresponding point on the first image content. For example, the point marker 210 may acquire a 360-degree static image or moving picture based on the center point selected by the user from the street view in the virtual exploration environment. That is, the point marker 210 may create a new 360-degree user-generated content (UGC) by capturing at least a portion of the first image content explored by the user. Here, in addition to the 360-degree panoramic image, the point marker 210 may capture at least a portion as a full-frame photo.

In operation S403, the point marker 210 may mark a specific point on the first image content during the process of creating the second image content. For example, if the second image content, for example, a 360-degree static image or a 360-degree moving picture, associated with the specific point is created from the street view, the point marker 210 may mark the corresponding point on the street view. Accordingly, if the new image content is created by performing 360-degree capturing of corresponding content associated with a desired point of the user through a capturing tool provided from the virtual exploration environment using the panoramic image, the point marker 210 may mark the corresponding point on the first image content as a specific point for a POI registration.

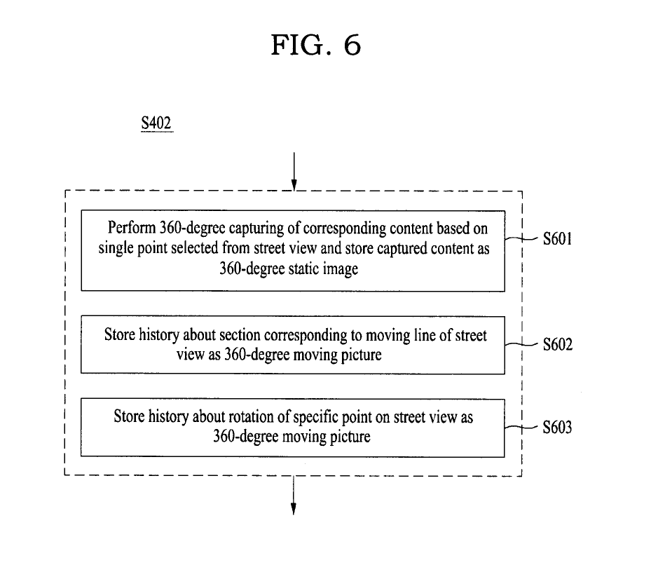

FIG. 6 is a flowchart illustrating an example of an image content creation process according to at least one example embodiment. Operations S601 through S603 of FIG. 6 may be included in operation S402 of FIG. 4 and thereby performed.

Second image content may be created in one of a static image format and a moving picture format.

For example, in operation S601, the point marker 210 may perform 360-degree capturing of corresponding content based on a single point selected by a user from a street view in the virtual exploration environment and may store the captured content as a 360-degree static image. The 360-degree static image may be viewed with the image being rotated 360 degrees, which differs from a general panoramic static image.

The street view image refers to a collection of consecutive photos captured along a moving line of a photographer. Consecutive 360-degree images moving between multiple points on the street view image may be consecutively captured and may be stored in a moving picture format. Here, the user may create a moving picture using two schemes.

In one scheme of creating the image content in the moving picture format, the point marker 210 may store the history about a section corresponding to a moving line of the street view and may store the history as a 360-degree moving picture in operation S602. The point marker 210 may create the image content in the moving picture format by selecting a movement section of the user from the street view, and by storing the history of the selected movement section.

As another scheme of creating the image content in the moving picture format, the point marker 210 may store the history about rotation of a specific point on the street view and may store the history as the 360-degree moving picture in operation S603. The point marker 210 may create the image content in the moving picture format in such a manner that the user rotates a screen of a specific point on the street view and stores the history of the rotation.

When the user sets a movement section by directly manipulating a street view to create the image content in the moving picture format, the image content may be stored at a uniform speed by ignoring a user manipulation delay and the like. Here, a movement speed may be directly set by the user.

As described above, once the user captures a desired static image/moving picture through a predetermined process using the image content in the panoramic format, the computer system 100 may create a 360-degree static image/moving picture file based on a condition set by the user and may mark a place corresponding to the static image/moving picture captured from the street view in a virtual exploration environment as a specific point for a POI registration.

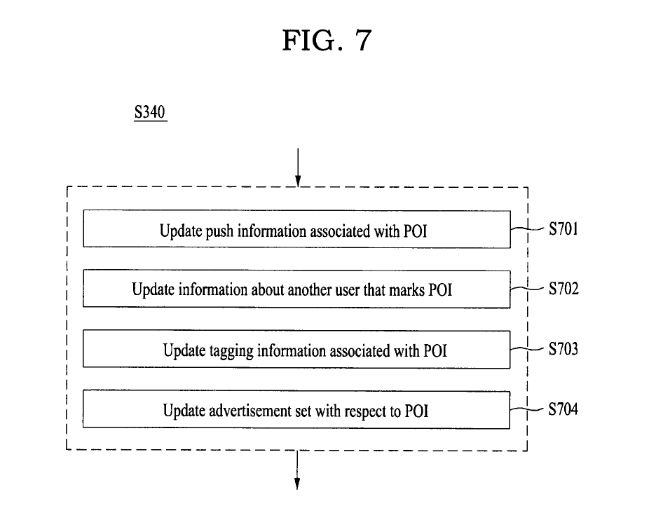

FIG. 7 is a flowchart illustrating an example of an automatic update method performed by the updater 230 according to one example embodiment. Operations S701 through S704 of FIG. 7 may be included in operation S340 of FIG. 3 and thereby performed.

The updater 230 may automatically update information data associated with a corresponding point based on location information of the POI.

For example, in operation S701, the updater 230 may update push information associated with location information corresponding to a POI of a user. A platform or another service platform that services a virtual exploration environment using a panoramic image may provide push information based on location information. The updater 230 may update push information corresponding to the POI.

As another example, in operation S702, the updater 230 may update information about another user that marks the corresponding point based on location information corresponding to the POI of the user. The updater 230 may update users that are present at the same point or similar points. Thus, the updater 230 may update another user that marks a point corresponding to the same location information as the POI of the user or location information within a predetermined radius from the POI of the user. Here, the updater 230 may select and update a user corresponding to a preset update condition, for example, age, gender, region, etc., from among other users that mark the corresponding point based on location information corresponding to the POI of the user.

As another example, in operation S703, the updater 230 may update tagging information associated with location information corresponding to the POI of the user. That is, the updater 230 may update information data that includes location information corresponding to the POI of the user among information data, for example, photos, news, blogs, etc., on the Internet in which location information is included in a tag.

As another example, in operation S704, the updater 230 may update an advertisement set with respect to location information corresponding to the POI of the user. The updater 230 may update an advertisement that includes location information corresponding to the POI of the user as a targeting region, among advertising contents that include location information in a targeting element. In addition to a method of updating an advertisement based on location information, the updater 230 may update an advertisement that includes user information, for example, age, gender, region, etc., in a target element.

Accordingly, the computer system 100 may update information data included in a virtual exploration environment of a corresponding point with respect to the POI of the user or information data associated with location information corresponding to the POI of the user.

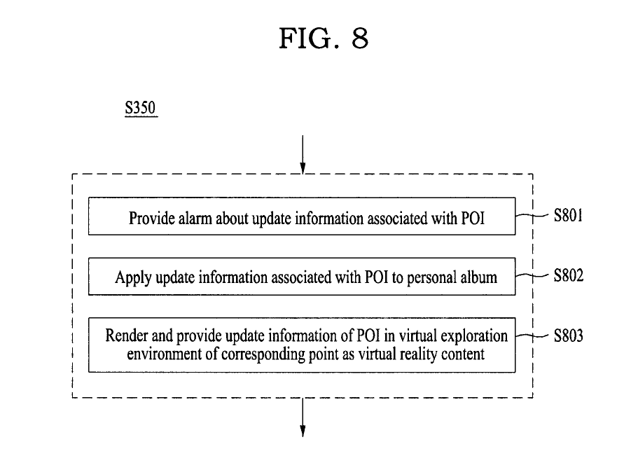

FIG. 8 is a flowchart illustrating an example of an update information providing method performed by the information manager 240 according to one example embodiment. Operations S801 through S803 of FIG. 8 may be included in operation S350 of FIG. 3 and thereby performed.

The information manager 240 may provide update information associated with a POI of a user using a variety of methods. The update information may be, for example, push information data associated with a corresponding region, information about users that are present in the same region, tagging information data associated with the corresponding region, advertising contents set with respect to the corresponding region, and the like.

For example, in operation S801, the information manager 240 may provide an alarm about update information associated with the POI of the user. Here, the information manager 240 may archive update information of a virtual exploration environment associated with the POI of the user, and may automatically issue an alarm when a change occurs in the POI of the user. In this manner, a timeline archive about the virtual exploration environment of the POI may be constructed. That is, once information data associated with the POI of the user is updated, the information manager 240 may provide an alarm about corresponding update information to the user or may transmit the corresponding information data to the user. In addition to the alarm about the update information associated with the POI of the user, the information manager 240 may provide a function that enables the user to be directed to the corresponding point. Further, the information manager 240 may provide a function of marking and displaying an updated portion through comparison to a previous image, content, etc, using the timeline archive about the POI of the user, or a function of comparing and displaying only a corresponding point in which a change of a predetermined threshold or more has occurred.

As another example, in operation S802, the information manager 240 may apply update information associated with the POI of the user to a personal album associated with the user. The information manager 240 may create the personal album of the user by automatically attaching and storing latest update information associated with the corresponding point in response to updating of information data associated with the POI of the user. In addition to the personal album, the information manager 240 may manage update information associated with the POI of the user as personal user information in conjunction with another service platform, such as a cloud service and the like.

As another example, in operation S803, the information manager 240 may render and provide update information associated with the POI of the user using the virtual exploration environment of the corresponding point. For example, once information data associated with the POI is updated, the information manager 240 may render and display the updated information data as virtual reality content in a street view of the corresponding point.

Accordingly, the computer system 100 may easily and conveniently track a change in a corresponding place through presetting and automatic updating associated with a POI without requiring a user to search the POI each time.

According to some example embodiments, it is possible to construct a timeline archive about a virtual exploration environment of a POI by automatically updating a marked POI in the virtual exploration environment. Also, according to some example embodiments, it is possible to automatically attach recent information associated with a corresponding region in response to updating of a POI of a user or to automatically transmit or provide an alarm about the recent information, so that the user may easily track a change in the point of interest without performing search every time.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for automatically updating a marked point of interest in a virtual exploration environment performed in an automatic update system configured as a computer, the method comprising:
marking a specific point in a virtual exploration environment using a panoramic image;
updating information data associated with the specific point using location information corresponding to the specific point; and
providing update information associated with the specific point to a user that marks the specific point.

2. The method of claim 1, wherein the marking comprises marking the specific point in response to viewing the virtual exploration environment associated with the specific point.

3. The method of claim 1, wherein the marking comprises marking the specific point in response to creating image content associated with the specific point using the virtual exploration environment.

4. The method of claim 1, wherein the updating comprises updating information data included in a virtual exploration environment of the specific point.

5. The method of claim 1, wherein the updating comprises updating information data associated with location information corresponding to the specific point.

6. The method of claim 1, wherein the updating comprises updating push information associated with location information corresponding to the specific point.

7. The method of claim 1, wherein the updating comprises updating information associated with users that mark the same point as the specific point or a point adjacent to the specific point.

8. The method of claim 1, wherein the updating comprises updating tagging information associated with location information corresponding to the specific point.

9. The method of claim 1, wherein the updating comprises updating advertising content set with respect to location information corresponding to the specific point.

10. The method of claim 1, wherein the providing comprises providing an alarm about update information associated with the specific point.

11. The method of claim 1, wherein the providing comprises applying update information associated with the specific point to a personal album of the user.

12. The method of claim 1, wherein the providing comprises rendering update information associated with the specific point and representing the rendered update information on a virtual exploration environment of the specific point as virtual reality content.

13. The method of claim 1, further comprising:
providing a virtual space allowing users that mark the specific point to share data with respect to the specific point.

14. The method of claim 13, further comprising:
providing an alarm to at least a portion of the users that mark the specific point in response to uploading of the data through the virtual space.

15. A non-transitory computer-readable medium storing computer-readable instructions that, when executed by a processor, cause the processor to perform steps for automatically updating a marked point of interest in a virtual exploration environment, the steps comprising:
marking a specific point in a virtual exploration environment using a panoramic image;
updating information data associated with the specific point using location information corresponding to the specific point; and
providing update information associated with the specific point to a user that marks the specific point.

16. An automatic update system configured as a computer for automatically updating a marked point of interest in a virtual exploration environment, the system comprising:
a point marker configured to mark a specific point in a virtual exploration environment using a panoramic image;
an updater configured to update information data associated with the specific point using location information corresponding to the specific point; and
an information manager configured to provide update information associated with the specific point to a user that marks the specific point.

17. The automatic update system of claim 16, wherein the information manager is configured to provide an alarm about update information associated with the specific point.
